(19) United States
(12) Patent Application Publication
(10) Pub. No.: US 2013/0338959 A1
(43) Pub. Date: Dec. 19, 2013

(54) SWITCHING-TYPE CATEGORIZING AND TESTING STRUCTURE OF RFIC

(71) Applicants: YUN-PENG HO, New Taipei City (TW); Liang-Po Chen, New Taipei City (TW)

(72) Inventors: YUN-PENG HO, New Taipei City (TW); Liang-Po Chen, New Taipei City (TW)

(21) Appl. No.: 13/523,895

(22) Filed: Jun. 15, 2012

(51) Int. Cl. G06F 19/00

(52) U.S. Cl. 702/117

(57) ABSTRACT

A switching-type categorizing and testing apparatus of a Radio Frequency integrated Circuit (RFIC) is used to test and categorize at least one RFIC module. The apparatus comprises at least one testing module and a plurality of categorizing modules. The testing module is used to test the RFIC module, and the categorizing modules comprise a first categorizing module and a second categorizing module. The testing module tests the RFIC module within one of the two categorizing modules at the same when the other categorizing module categorizes the RFIC module already tested. The present invention may further increase the testing and categorizing quantity so as to achieve the fast and cost-saving advantages.

### BACKGROUND OF THE INVENTION

a) Field of the Disclosure

The present invention relates to a testing and categorizing structure for an IC (Integrated Circuit), and more particularly, to the switching-type categorizing and testing structure which is fast and cost-saving for RFIC (Radio Frequency Integrated Circuit).

b) Description of the Prior Art

In the present market, the conventional testing and categorizing apparatus for RFIC can be divided into two types. One is a RFIC testing apparatus combined with an independently operated IC auto-categorizing machine. And the other one is the expensive integrated apparatus. However, the testing time and efficiency of the testing apparatus has been approaching to the performance of the single testing station of the expensive integrated apparatus.

Furthermore, the testing function of the integrated apparatus is idle when the categorizing function is proceeding so that the integrated apparatus does not have the highest efficiency. On the other hand, the RFIC testing time of the testing apparatus is getting shorter and shorter and is more and more approaching to the distribution time of the IC auto-categorizing machine. Therefore, the bottleneck of the time and cost for RFIC testing and production has been switched from the testing to the IC categorizing.

### SUMMARY OF THE INVENTION

In view of the aforementioned disadvantages of the conventional testing and categorizing apparatus for RFIC, the inventor invents the present invention, the switching-type categorizing and testing structure which is fast and cost-saving for RFIC, through continuously researching, testing, and modifying the related techniques according to the abundant experience in the art of the inventor.

The major object of the present invention is to solve the problem of the conventional testing and categorizing apparatus for RFIC that the integrated apparatus is costly, whereas the independent apparatus is time-consuming. Then, the fast and cost-saving goal is obtained by the present invention which is innovative and very useful in the industry

To achieve the object mentioned above, the present invention is to provide a switching-type categorizing and testing structure of the RFIC, which is a categorizing and testing apparatus to test and categorize at least one RFIC module. The categorizing and testing apparatus includes at least one testing module and a plurality of categorizing modules. The testing module is used to test the RFIC module and generate a categorizing instruction unit after testing each RFIC module. And, the categorizing modules are used to receive the categorizing instruction unit and then categorize the RFIC module according to the categorizing instruction unit. The categorizing modules include a first categorizing module and a second categorizing module, which have information connection to the testing module and are used to categorize the RFIC module respectively. By this configuration, the second categorizing module proceeds the categorizing operation to the RFIC module already tested by the testing module at the same time when the testing module tests the RFIC module within the first categorizing module. Therefore, the basic operation principle is that the testing module tests the RFIC module within one of the two categorizing modules at the same when the other categorizing module categorizes the RFIC module already tested by the testing module.

Consequently, the present invention may efficiently utilize the limited resource to further increase the testing and categorizing quantity so as to achieve the fast and cost-saving advantages.

Other objects, technical contents, features and advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a solid assembly schematic diagram according to the preferred embodiment of the present invention;

FIG. 2A is a schematic diagram of the first operation according to one preferred embodiment of the present invention;

FIG. 2B is a schematic diagram of the second operation according to one preferred embodiment of the present invention;

FIG. 2C is a schematic diagram of the third operation according to one preferred embodiment of the present invention;

FIG. 3A is a schematic diagram of the first operation according to another preferred embodiment of the present invention;

FIG. 3B is a schematic diagram of the second operation according to another preferred embodiment of the present invention;

FIG. 3C is a schematic diagram of the third operation according to another preferred embodiment of the present invention; and

FIG. 3D is a schematic diagram of the fourth operation according to another preferred embodiment of the present invention.

### DESCRIPTION OF THE PREFERRED EMBODIMENT

The detailed explanation of the present invention is described as following. The described preferred embodiments are presented for purposes of illustrations and description, and they are not intended to limit the scope of the present invention.

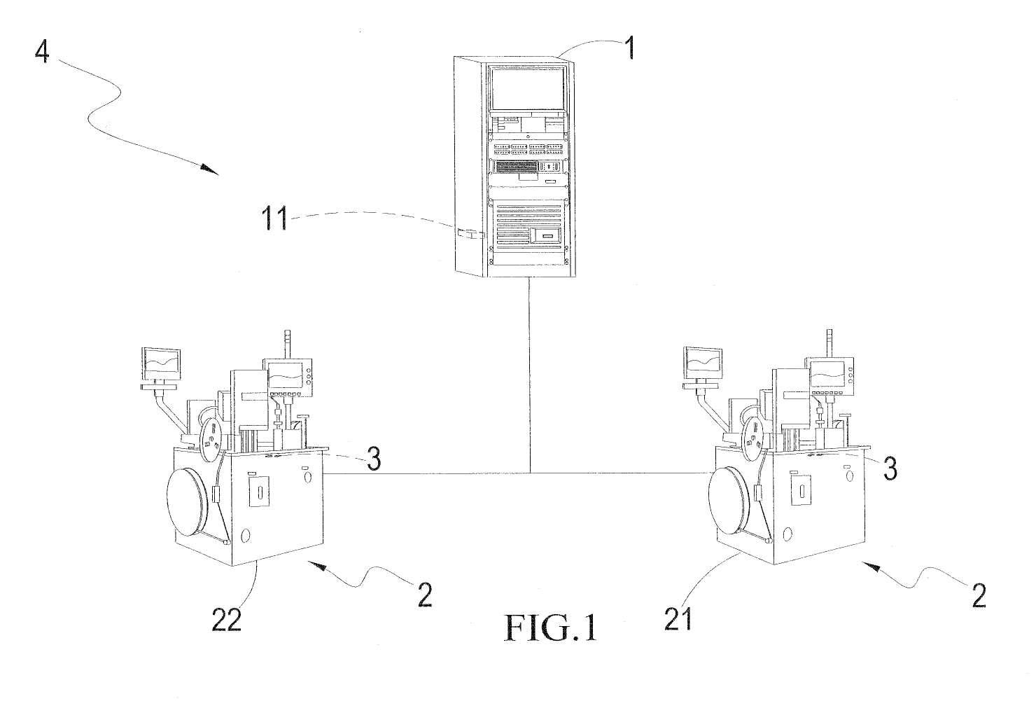

Please refer to FIG. 1, which is a solid assembly schematic diagram according to the preferred embodiment of the present invention. The switching-type categorizing and testing structure of the RFIC of the present invention is clearly shown in FIG. 1, which is a categorizing and testing apparatus 4 to test and categorize at least one RFIC module 3. The categorizing and testing apparatus includes at least one testing module 1 and a plurality of categorizing modules 2. The testing module 1 is used to test the RFIC module 3 and generate a categorizing instruction unit 11 after testing each RFIC module. And, the categorizing modules 2 are used to receive the categorizing instruction unit 11 and then categorize the RFIC module 3 according to the categorizing instruction unit 11. The categorizing modules 3 include a first categorizing module 21 and a second categorizing module 22, which have information connection to the testing module 1 and are used to categorize the RFIC module 3 respectively. By this configuration, the second categorizing module 22 proceeds the categorizing operation to the RFIC module 3 already tested by the testing module 1 at the same time when the testing module 1 tests the RFIC module 3 within the first categorizing module 21.

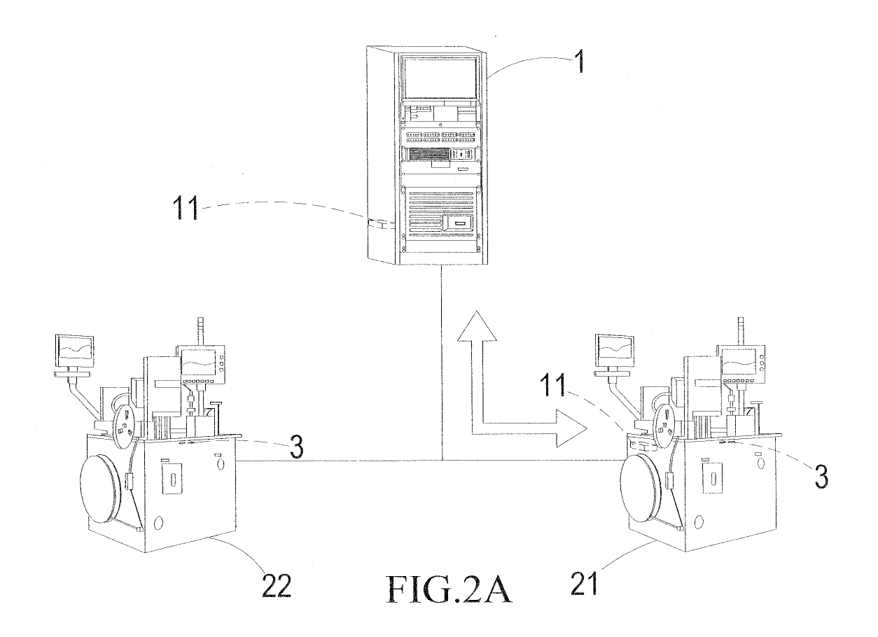

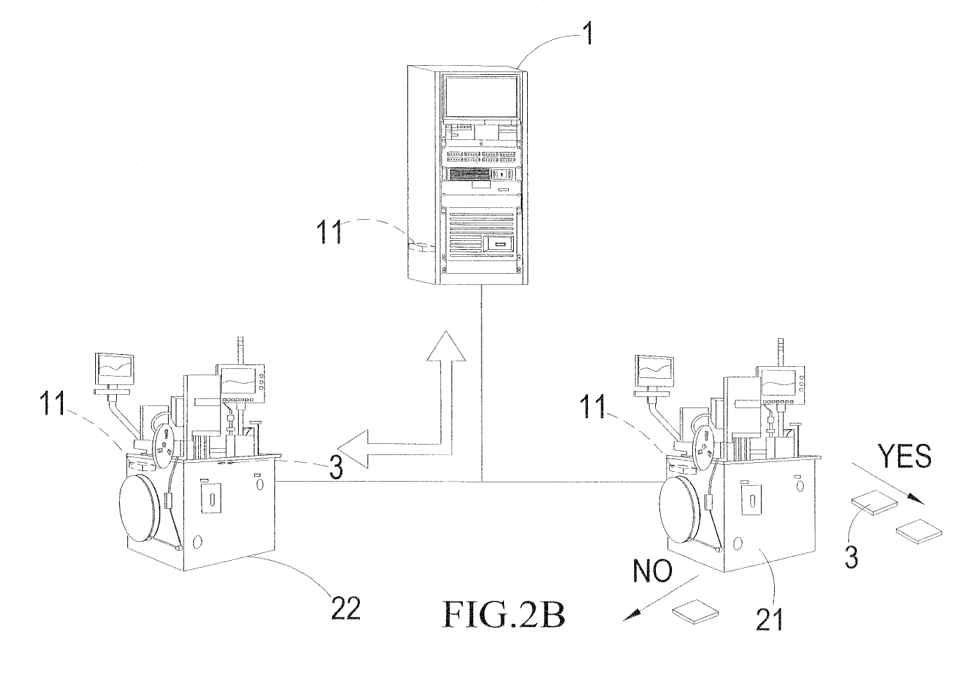

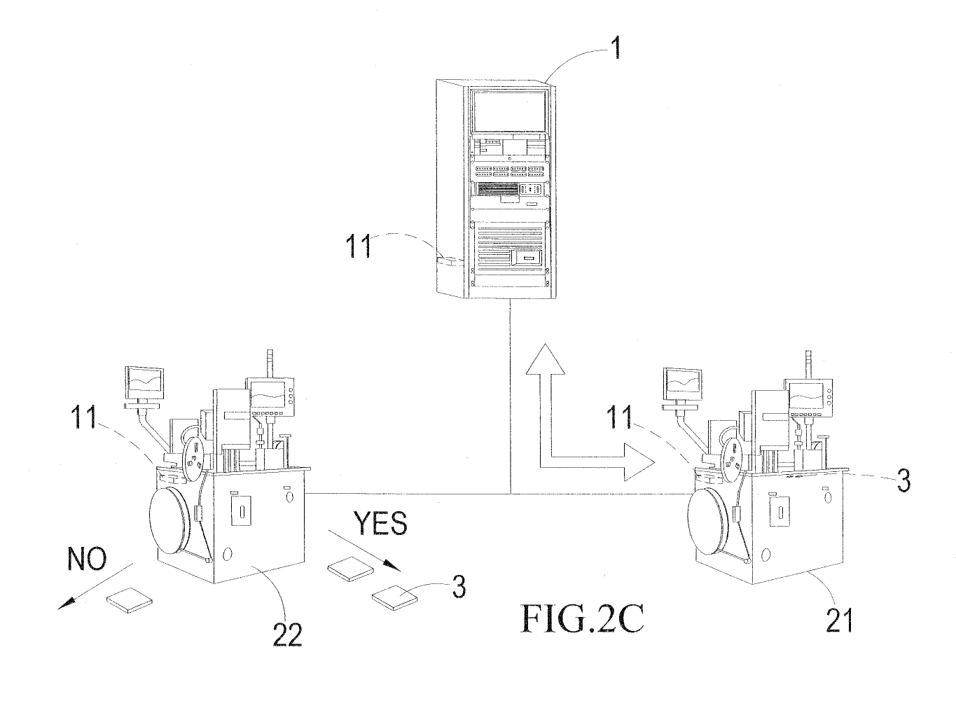

By the aforementioned configuration, the operation details of the invention are described in the following. Please simultaneously refer to FIG. 2A, FIG. 2B, and FIG. 2C, which are the first, second, and third operation schematic diagrams according to one preferred embodiment of the present invention. The figures clearly show that through applying the testing module 1 which testing speed is the same as the conventional integrated apparatus, the cost is far lower than the conventional integrated categorizing apparatus although the testing quantity at a time of the testing module 1 is fewer than the conventional integrated apparatus. The second categorizing module 22 proceeds the categorizing operation to the RFIC module 3 already tested by the testing module 1 at the same time when the testing module 1 tests the RFIC module 3 within the first categorizing module 21. Therefore, the testing module 1 is continuously proceeding the switching testing operation between the first categorizing module 21 and the second categorizing module 22. And following this, the first categorizing module 21 and the second categorizing module 22 are proceeding the categorizing operation according to the categorizing instruction unit 11. Consequently, the conventional waiting time is saved and so as to increase the testing quantity of the RFIC module 3.

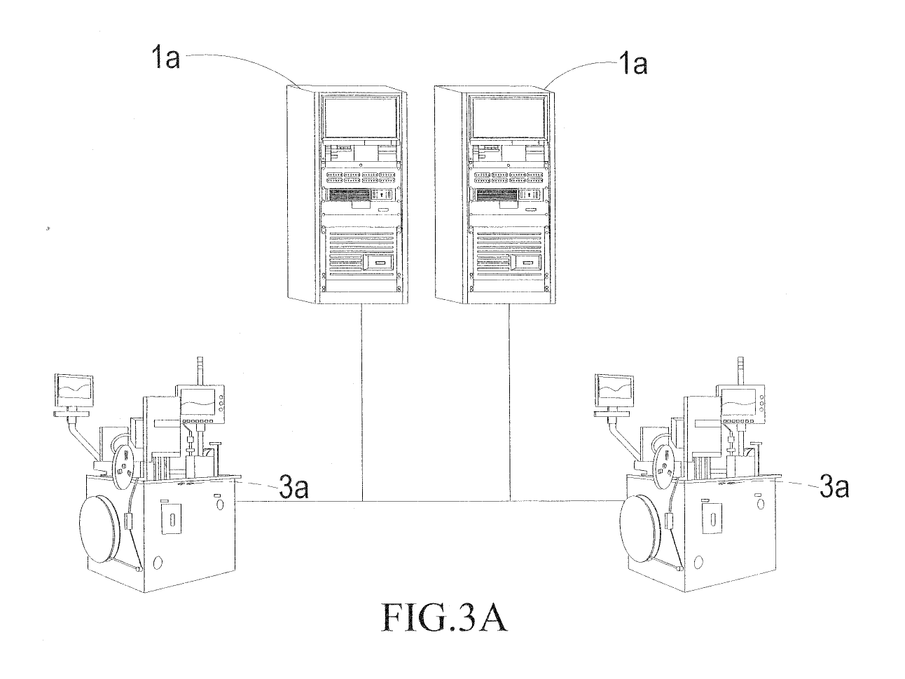

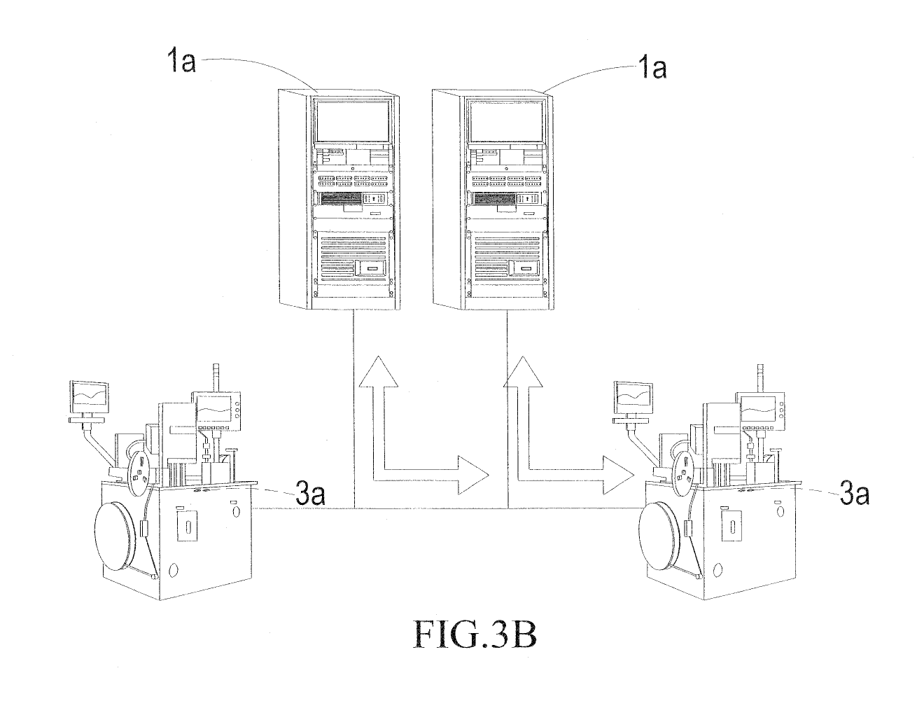

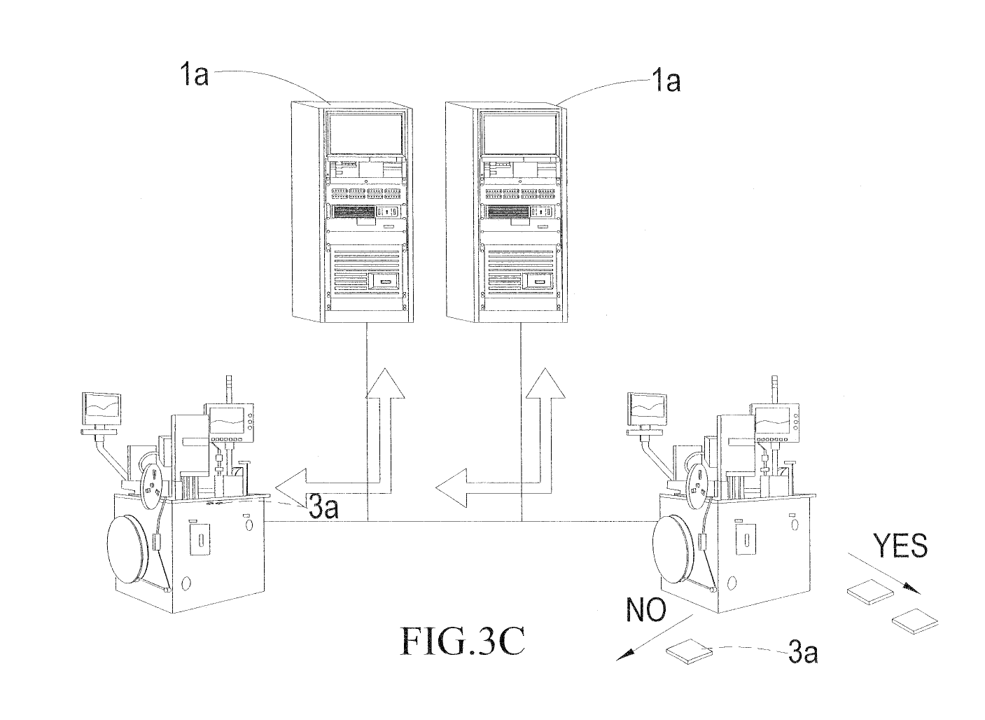

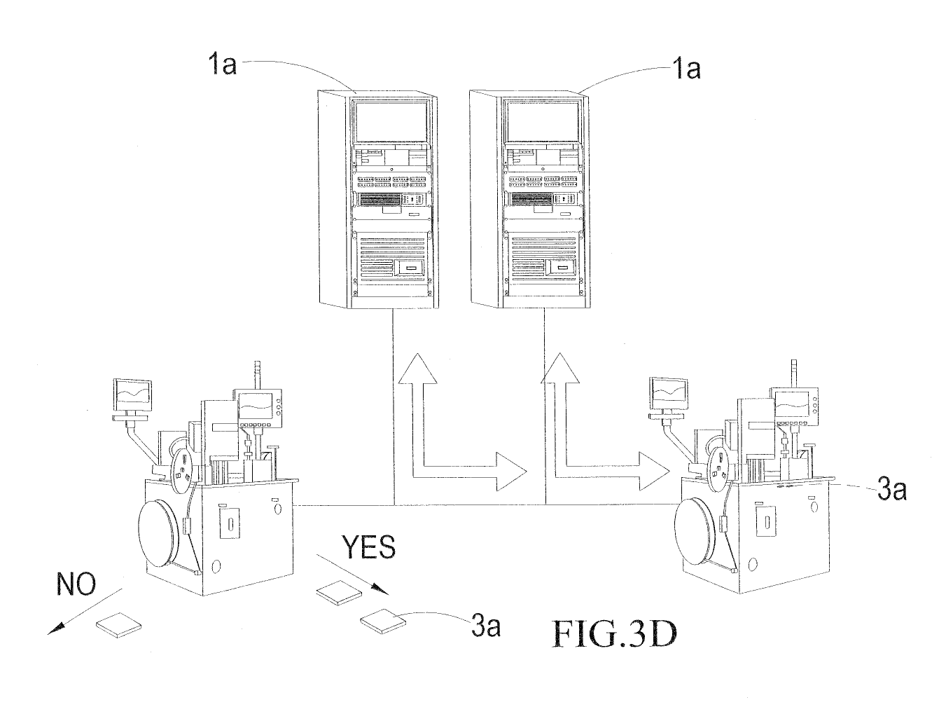

Please simultaneously refer to FIG. 3A, FIG. 3B, FIG. 3C, and FIG. 3D, which are the first, second, third, and fourth operation schematic diagrams according to another preferred embodiment of the present invention. The figures clearly show that a plurality of testing modules 1a alternatively test the RFIC module 3a together. Besides saving the time and cost of testing, it may further increase the testing quantity of the RFIC module 3a to lower down the overall cost and achieve higher testing efficiency by copying a low-cost testing module 1a of RFIC module without expanding any additional hardware and categorizing unit.

To make a brief summary, please refer to all of the figures, the present invention has the following advantages comparing to the conventional techniques:

A. The hardware cost is far lower than the conventional integrated testing and categorizing apparatus;

B. The testing module 1 is continuously proceeding the switching testing operation between the first categorizing module 21 and the second categorizing module 22. Consequently, the conventional waiting time is saved and so as to increase the testing quantity of the RFIC module 3; and

C. A plurality of testing modules 1a alternatively test the RFIC module 3a together. Besides saving the time and cost of testing, it may further increase the testing quantity of the RFIC module 3a to lower down the overall cost and achieve higher testing efficiency by copying a low-cost testing module la of RFIC module without expanding any additional hardware and categorizing unit.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. An switching-type categorizing and testing structure of a Radio Frequency Integrated Circuit (RFIC) which is a categorizing and testing apparatus to test and categorize at least one RFIC module, comprising:
at least one testing module, wherein the testing module is used to test the RFIC module; and
a plurality of categorizing modules; wherein the categorizing modules comprise a first categorizing module and a second categorizing module, which have information connection to the testing module and are used to categorize the RFIC module respectively; wherein the second categorizing module proceeds the categorizing operation to the RFIC module already tested by the testing module at the same time when the testing module tests the RFIC module within the first categorizing module; wherein by this way, the testing module tests the RFIC module within one of the two categorizing modules at the same when the other categorizing module categorizes the RFIC module already tested by the testing module.

2. The switching-type categorizing and testing structure of a RFIC according to claim 1, wherein the testing module generates a categorizing instruction unit after testing each of the RFIC modules.

3. The switching-type categorizing and testing structure of a RFIC according to claim 2, wherein the categorizing modules receive the categorizing instruction unit and then categorize the RFIC module according to the categorizing instruction unit.
